(19) United States
(12) Patent Application Publication
(10) Pub. No.: US 2026/0213537 A1
(43) Pub. Date: Jul. 23, 2026

(54) INTERLINE POWER FLOW CONTROLLER

(71) Applicant: Hitachi Energy Ltd, Zürich (CH)

(72) Inventors: Debrup DAS, Apex, NC (US); Ghanshyamsinh Vijaysinh GOHIL, Apex, NC (US)

(21) Appl. No.: 19/137,180

(22) PCT Filed: Dec. 16, 2022
(86) PCT No.: PCT/EP2022/086397

§ 371 Date: Jun. 9, 2025

(51) Int. Cl. H02J 3/175; H02J 3/001; H02J 3/007; H02J 103/35

(52) U.S. Cl. CPC H02J 3/175; H02J 3/001; H02J 3/0075; H02J 2103/35

(57) ABSTRACT

A power flow controller includes a voltage source converter including an alternating current (AC) voltage output configured to be simultaneously coupled to a first power transmission line and a second power transmission line. The voltage source converter is configured to generate, at the AC voltage output, AC voltage to be injected into the first power transmission line with additive polarity and into the second power transmission line with subtractive polarity to perform complementary compensation on the first and second power transmission lines. The power flow controller may further include a controller coupled to the voltage source converter and configured to control the phase angle of the AC voltage relative to at least one of the phase angles of the first and second power transmission line currents.

### TECHNICAL FIELD

The present invention relates generally to alternating current power transmission systems, and, in particular embodiments, to structures of power flow controllers, power flow control systems, and methods of operation thereof.

### BACKGROUND

Electric power is becoming an increasingly important aspect of modern life. Consumers are using more and more electricity from a growing number of diverse sources. Electric power is delivered as alternating current (AC) power using electricity networks, which utilize a high voltage transmission grid to transmit large quantities of electricity over large distances, and a lower voltage distribution gird to deliver electric power in a usable form to consumers.

One type of electricity network topology is a mesh network. Mesh networks are useful because they provide a high level of interconnectivity allowing power flow over many different paths between nodes. This redundancy is beneficial for grid reliability and flexibility. One drawback of a mesh network is its potential complexity. Highly adaptable mesh networks may have many power transmission paths and interconnected nodes that have vastly different properties.

Using the various transmission paths in the most efficient manner may be challenging. Under light loads, electricity's path from the sending node to the receiving node has little or no impact on the ability of the network to transmit power. Even though some paths may be more favorable than others, the load is too small to overload any portion of the network. However, under heavy loads, mismatches in impedance between various paths can limit power throughput by overloading low impedance paths. Power flow control is used to try to divert power away from the overloaded portions of the network.

Each component of the network has a predetermined safe operating point called a voltage-ampere (VA) rating. If the VA rating is met or exceeded, power flow must be limited to prevent dangerous conditions in the network. Conventional power flow controllers use equipment that has a high VA rating. Yet, equipment with a high VA rating is usually not the most effective solution because achieving a higher VA rating is costly, increases equipment size, and limits the flexibility of implementation. Therefore, a power flow controller that is compact, flexible, inexpensive, and requires a lower VA rating may be desirable.

U.S. Pat. No. 10,044,187 B2 discloses a common power flow controller.

It is an object to provide an improved power flow controller and a method of power flow control with a batter utilization of a power converter and reduced converter rating. This object is solved by the features of the independent claims.

### SUMMARY

In accordance with an embodiment, a power flow controller includes a voltage source converter including an AC voltage output configured to be simultaneously coupled to a first power transmission line and a second power transmission line. The voltage source converter is configured to generate, at the AC voltage output, AC voltage to be injected into the first power transmission line with additive polarity and into the second power transmission line with subtractive polarity to perform complementary compensation on the first and second power transmission lines. The power flow controller further includes a controller coupled to the voltage source converter and configured to control the phase angle of the AC voltage relative to at least one of the phase angles of the first and second power transmission line currents.

In accordance with another embodiment, a power flow control system includes a first pair of current input/output nodes configured to be coupled in series with a first power transmission line, a second pair of current input/output nodes configured to be coupled in series with a second power transmission line, and a first interline power flow controller (IPFC) circuit. The first IPFC circuit includes a first voltage source converter configured to output a first AC voltage out of phase with line currents of the first and second power transmission lines, a first line one transformer including a primary winding coupled across the first AC voltage, and a secondary winding coupled between the first pair of current input/output nodes, and a first line two transformer including a primary winding coupled across the first AC voltage, and a secondary winding coupled between the second pair of current input/output nodes. The first line one transformer has additive winding polarity while the first line two transformer has subtractive winding polarity.

In accordance with still another embodiment, a method of power flow control includes reading system data indicating a present state of an AC power system, determining that there is power flow congestion on a first power transmission line of the AC power system using load flow calculations of the AC power system determined using the system data, and in response to determining that there is power flow congestion, performing complementary compensation of the first power transmission line and a second power transmission line of the AC power system. The complementary compensation is performed by injecting an out of phase voltage into the first power transmission line with additive polarity and injecting the out of phase voltage into the second power transmission line with subtractive polarity using a power flow controller coupled to both the first and second power transmission lines.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a schematic diagram of an example power flow controller that includes a converter coupled to two power transmission lines in accordance with embodiments of the invention;

FIG. 2 illustrates a conceptually equivalent circuit of the example power flow controller of FIG. 1;

FIG. 3 illustrates a schematic diagram of an example power flow controller that includes a converter coupled to two transformers, each in series with a power transmission line in accordance with embodiments of the invention;

FIG. 4 illustrates a schematic diagram of an example power flow control system that includes a power flow controller coupled to two power transmission lines on parallel paths from a first area to a second area in accordance with embodiments of the invention;

FIG. 5 illustrates a schematic diagram of a power flow control system that includes multiple power flow controllers coupled in series to two power transmission lines in accordance with embodiments of the invention;

FIG. 6 illustrates a high-level flowchart of a method of power flow control in an AC power transmission system using one or more power flow controllers coupled to two power transmission lines in accordance with embodiments of the invention;

FIG. 7 illustrates a schematic diagram of an example power flow control system including a power flow controller and two bypass circuits coupled to two power transmission lines in accordance with embodiments of the invention;

FIG. 8 illustrates a schematic diagram of an example bypass circuit including a fault detection device, a fast bypass switch, and a slow bypass switch in accordance with embodiments of the invention;

FIG. 9 illustrates a schematic diagram of an example converter implemented in a full-bridge configuration in accordance with embodiments of the invention;

FIG. 10 illustrates an example timing diagram of a response to a detected fault condition by bypass circuits of a power control system in accordance with embodiments of the invention;

FIG. 11 illustrates a schematic diagram of an example power flow control system including multiple power flow controllers and two bypass circuits coupled to two power transmission lines in accordance with embodiments of the invention;

FIG. 12 illustrates a schematic diagram of an example power flow controller that includes a converter coupled to two adjustable transformers, each in series with a power transmission line in accordance with embodiments of the invention;

FIG. 13 illustrates a schematic diagram of an example power flow controller that includes at least one disconnect switch configured to disconnect a converter from one of two power transmission lines in accordance with embodiments of the invention;

FIG. 14 illustrates a schematic diagram of an example an example power flow control system that includes a power flow controller coupled to three or more power transmission lines on parallel paths from a first area to a second area in accordance with embodiments of the invention;

FIG. 15 illustrates a schematic diagram of an example power flow controller that includes multiple converters coupled to two transformers, each in series with a power transmission line in accordance with embodiments of the invention;

FIG. 16 illustrates a schematic block diagram of an example power flow control system including multiple power flow controllers in a modular arrangement installed on an above-ground platform in accordance with embodiments of the invention;

FIG. 17 illustrates an AC power delivery system simplified as a two-area system;

FIG. 18 illustrates a conventional method of power flow control using impedance control by inserting an inductance into a power transmission line;

FIG. 19 illustrates a conventional method of power flow control using impedance control by inserting a capacitance into a power transmission line;

FIG. 20 illustrates a conventional method of power flow control using phase angle control by inserting a phase-shifting transformer into the power transmission line; and

FIG. 21 illustrates a conventional method of power flow control using phase angle control using series voltage injection into a single line with a power electronic converter.

Corresponding numerals and symbols in the different figures generally refer to corresponding parts unless otherwise indicated. The figures are drawn to clearly illustrate the relevant aspects of the embodiments and are not necessarily drawn to scale. The edges of features drawn in the figures do not necessarily indicate the termination of the extent of the feature.

### DETAILED DESCRIPTION OF ILLUSTRATIVE EMBODIMENTS

The making and using of various embodiments are discussed in detail below. It should be appreciated, however, that the various embodiments described herein are applicable in a wide variety of specific contexts. The specific embodiments discussed are merely illustrative of specific ways to make and use various embodiments, and should not be construed in a limited scope. Unless specified otherwise, the expressions “around”, “approximately”, and “substantially” signify within 10%, and preferably within 5% of the given value or, such as in the case of substantially zero, less than 10% and preferably less than 5% of a comparable quantity.

Meshed AC power transmission networks are commonly utilized in order to improve reliability. However, this reliability achieved by the meshed network topology also comes with the downside of reduced control of power flows. For example, as power requirements cause loads to shift throughout the meshed AC network, power will flow through the path of least impedance. Consequently, absent some form of power flow management, the throughput of the network is naturally limited by the first line in the path that is overloaded.

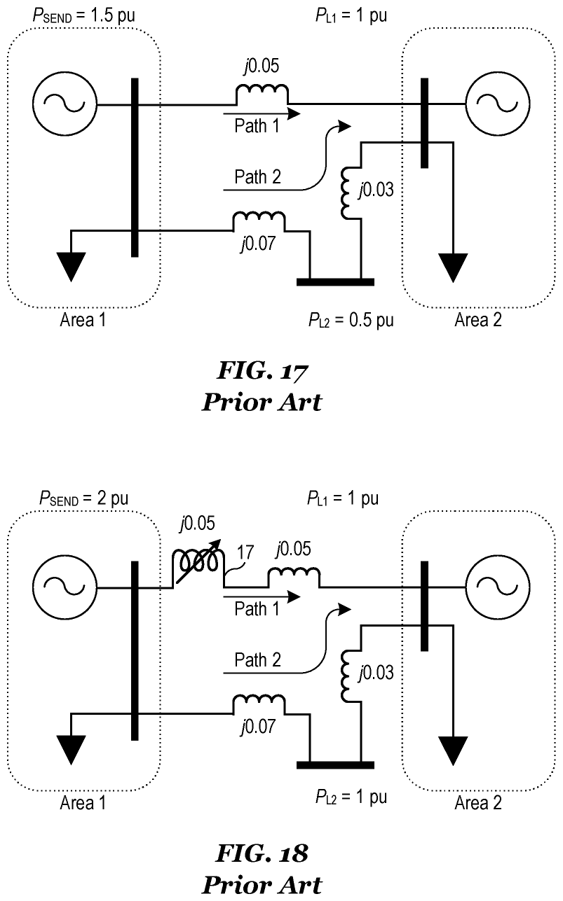

Although often much more complex in practice, the basic concept of this throughput limitation can be visualized by considering a simplified two-area system that is interconnected through a corridor with two parallel paths that have different line impedances. An example of such a system can be seen in FIG. 17. Although assumed to be present, path resistance will frequently be omitted from discussion herein for the sake of simplicity. Then, the impedance of Path 1 is shown as the reactance j0.05 which differs from the j0.1 reactance (j0.07+j0.03) of Path 2.

The difference in impedance between different paths is common in meshed transmission networks since the topology is designed to provide alternative paths between areas. Differences such as line length, the number and type of devices that are along the path, and other factors contribute to difference in impedance between different paths.

As shown in FIG. 17, the impedance mismatch limits the total power flow through the parallel paths to 1.5 pu (where ‘pu’ refers to a per-unit value of power that is expressed relative to a base quantity of the system). If, for example, the impedance of the two paths were to be balanced (e.g., the same or substantially the same), the total power flow through the parallel paths could be 2 pu, assuming the capacity of each line is 1 pu.

Since power flow is inversely proportional to the line impedances, more power flows through the lower impedance path. As a result, a line along the lower impedance path (here, path 1) will be the first to become overloaded in the event that the power flow from area 1 to area 2 continues to increase. The overloaded line limits the throughput of the power corridor even though the high impedance path is underutilized.

The capacity utilization of the transmission lines can be improved using PFCs. For example, PFCs can be used to modify characteristics of lines to manage power flow in a meshed AC network. Control over line characteristics can be broadly separated into two categories: impedance control and phase-angle control.

One method of power flow control using impedance control is to insert an inductance (e.g., a variable inductor 17) in the line with the least impedance, as illustrated in FIG. 18. This adds a positive reactance to the line impedance, increasing the impedance of path 1 to j0.1 and the total power throughput to 2 pu.

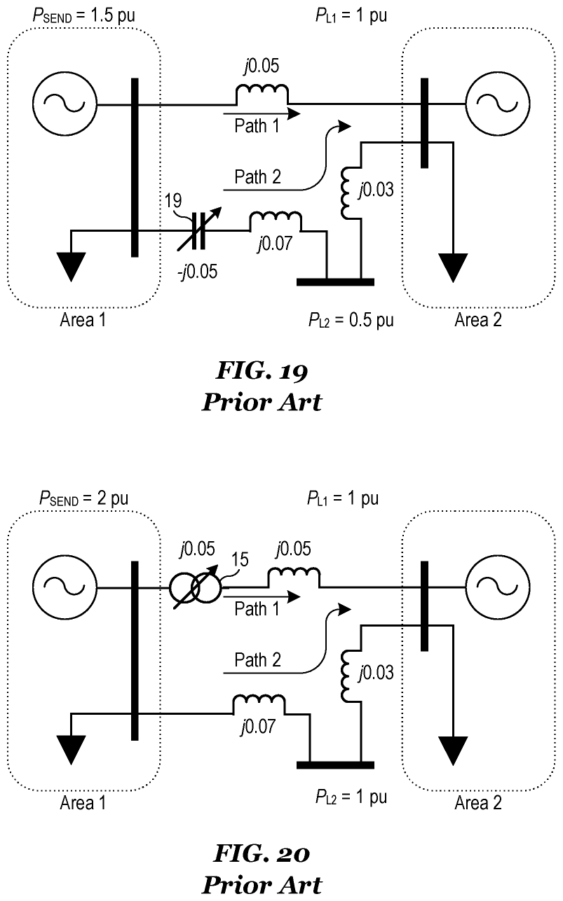

Another method of power flow control using impedance control is to insert a capacitance (e.g., a variable capacitor 19) in the line with the most impedance, as illustrated in FIG. 19. This adds a negative reactance to the line impedance, decreasing the impedance of path 2 to j0.05 and the total power throughput to 2 pu.

In contrast to impedance control, power flow control using phase angle control varies the phase angle of a line to control the phase angle between the sending end bus and the receiving end bus. For example, a phase-shifting transformer 15 (PST) can be inserted in the line to inject a variable voltage that is out of phase (e.g., a quadrature voltage) with the line current (e.g., using a tap changer), as illustrated in FIG. 20. The PST can control the line flow by varying the phase angle between the two buses through introduction of a regulated quadrature voltage to the phase voltage of the sending end bus. Here, a regulated quadrature voltage V_{S}′ of 1.0013∠2.86=−j0.05 is injected in path 1 which increases the path 1 impedance to −j0.1 and the total power throughput is increased to 2 pu, as shown.

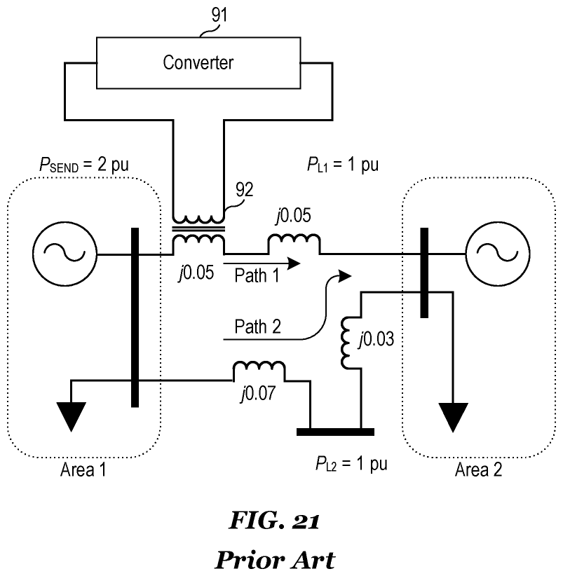

Another method of power flow control using phase angle control is series voltage injection using a power electronic converter. That is, regulated quadrature voltage injection can be achieved by coupling a voltage source converter 91 to the transmission line through a series transformer 92, as shown in FIG. 21. This configuration may be referred to as a Static Synchronous Series Compensator (SSSC). The voltage source converter operates to inject regulated voltage so that the SSSC behaves like a controllable series capacitor or series inductor (e.g., depending on the configuration of the transformer). Similar to the PST above, the SSSC injects a quadrature voltage resulting in −j0.05 being injected in path 1 and the total power throughput being increased to 2 pu.

Conventional single line solutions such as variable inductors, variable capacitors, PSTs or SSSCs have the drawback of high VA ratings and high cost. Additionally, one or more compensation elements such as a PST or SSSC would be required for every transmission line that might need to be adjusted further rising costs. These conventional solutions are also often cumbersome and require mounting on the substation floor as opposed to on platforms. Additionally, some solutions (e.g., variable inductors, variable capacitors, and PSTs) are comparably quite slow. Mesh power transmission networks increasingly require finer compensation tuning at higher speeds than conventional solutions can manage in order to meet the efficiency and performance demands of modern agile systems.

In various embodiments, a power flow controller includes a voltage source converter that generates an AC voltage at an output configured to be coupled to two power transmission lines. For example, the AC voltage output may be coupled to each of the lines using a transformer. The coupling between the converter and the lines is such that the AC voltage output by the converter is injected into one of the lines with additive polarity while the same AC voltage is injected into the other line with subtractive polarity.

A controller may be included in the power flow controller (or externally). The controller may be coupled to the converter and configured to control the phase angle of the AC voltage relative to at least one of the phase angles of the first and second power transmission lines to facilitate the complementary compensation of the two power transmission lines.

The asymmetric coupling configuration allows the AC voltage supplied by the converter to increase the impedance of the first power transmission line while decreasing the impedance of the second line. That is, the AC voltage injection simultaneously performs complementary compensation on the two power transmission lines.

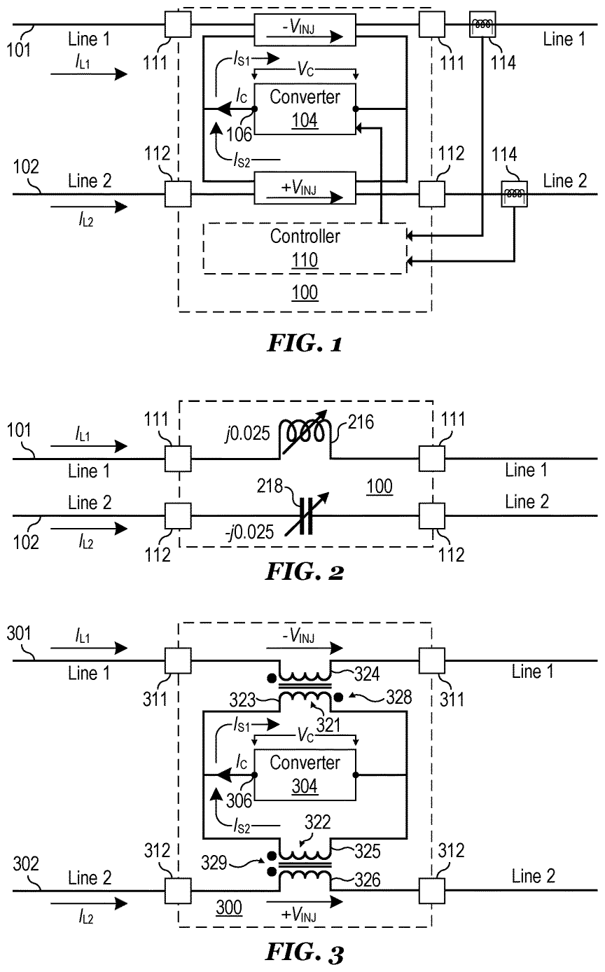

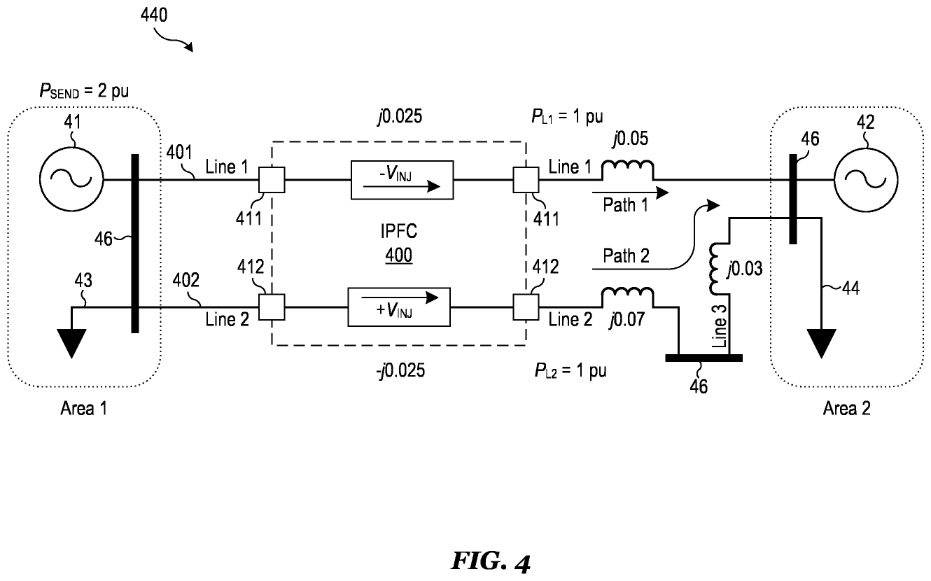

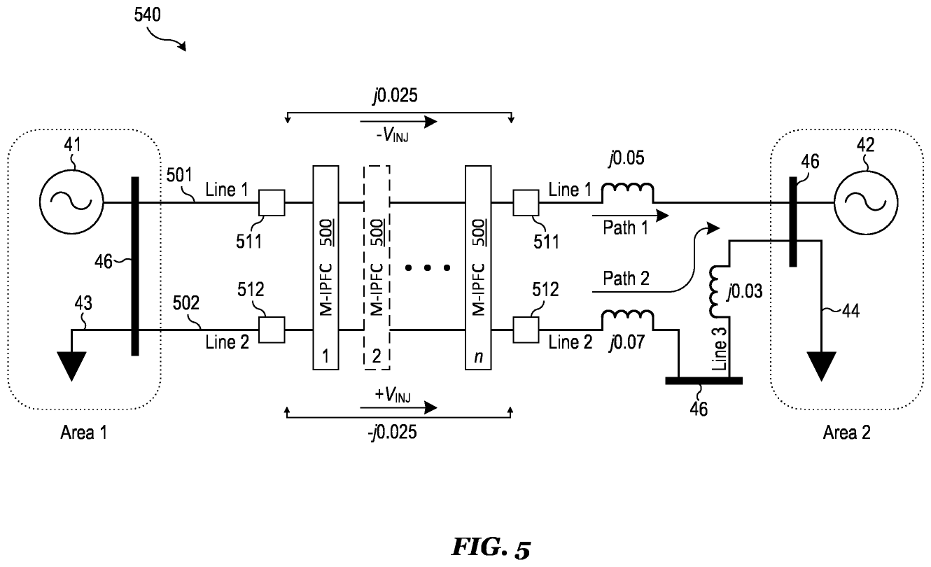

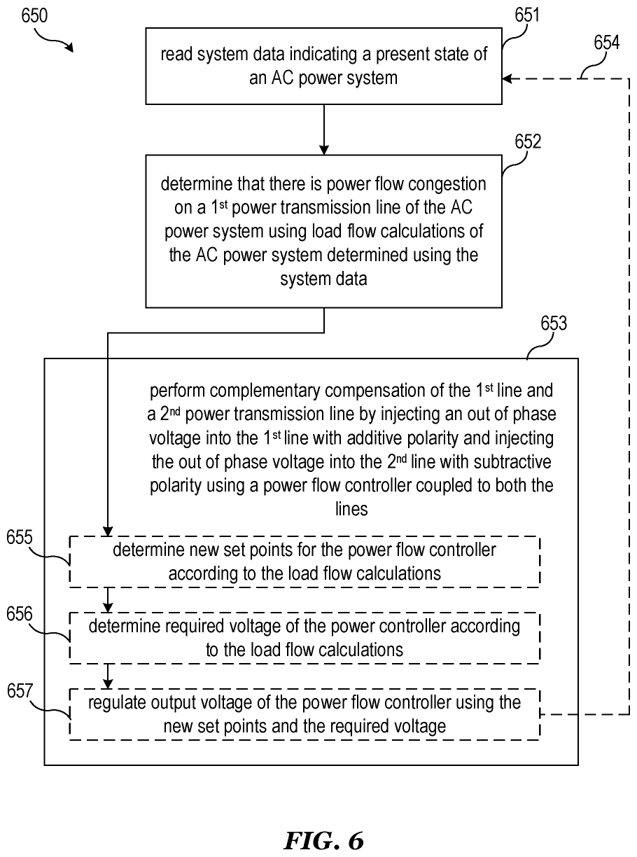

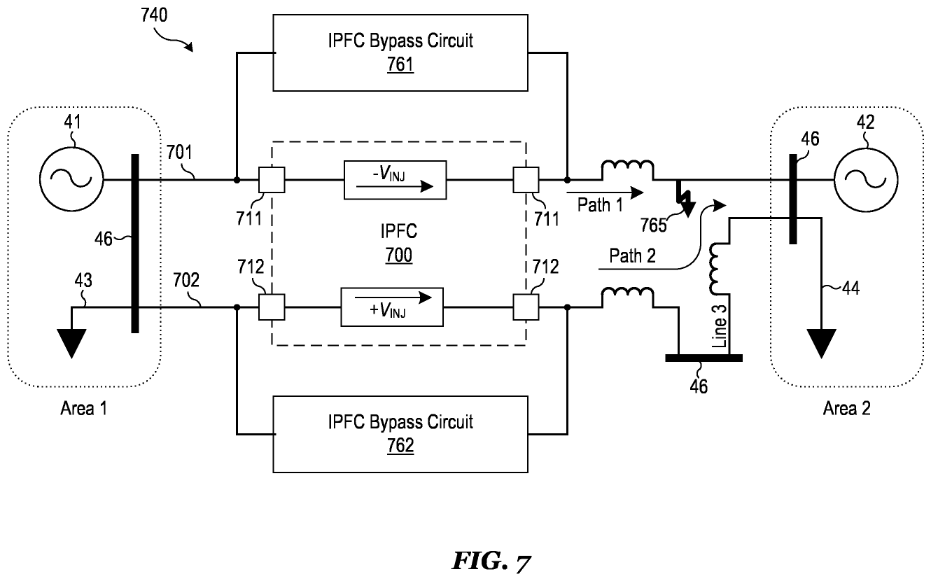

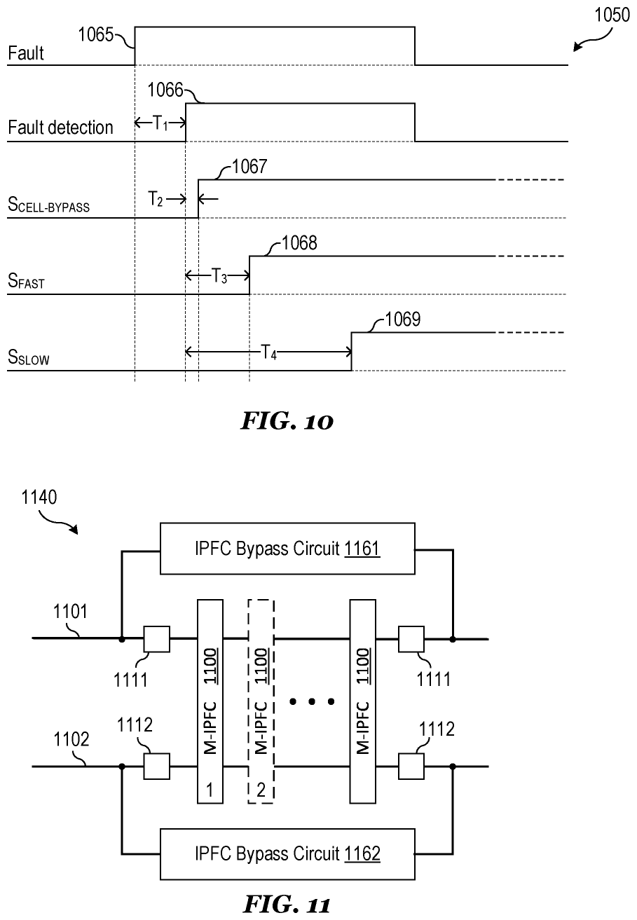

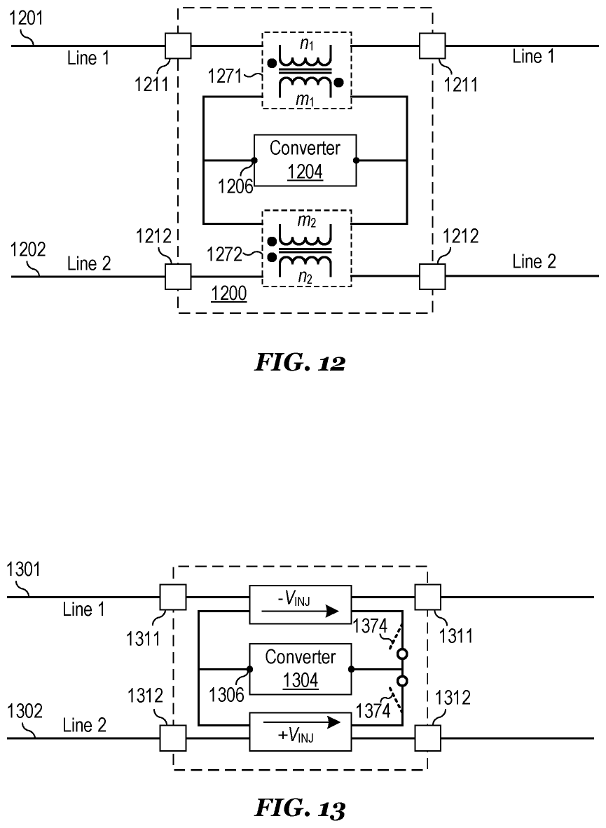

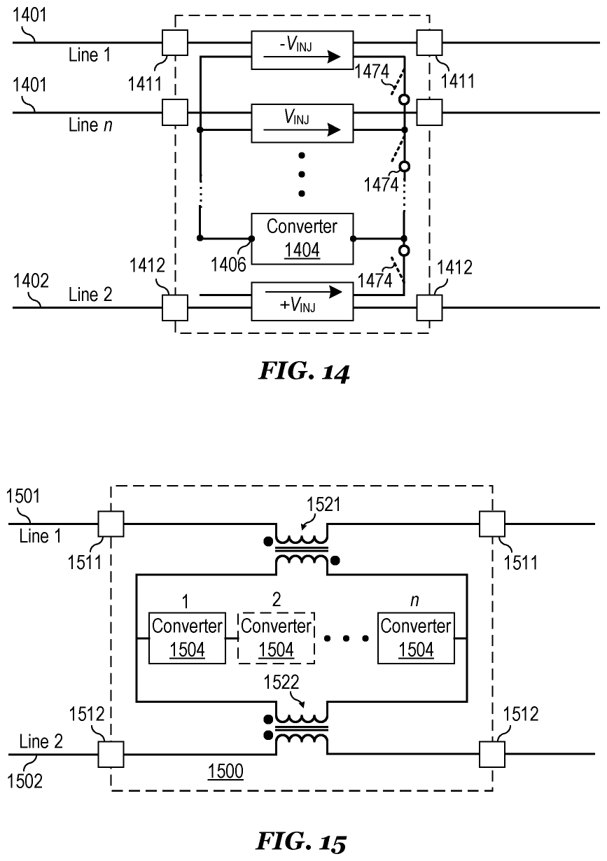

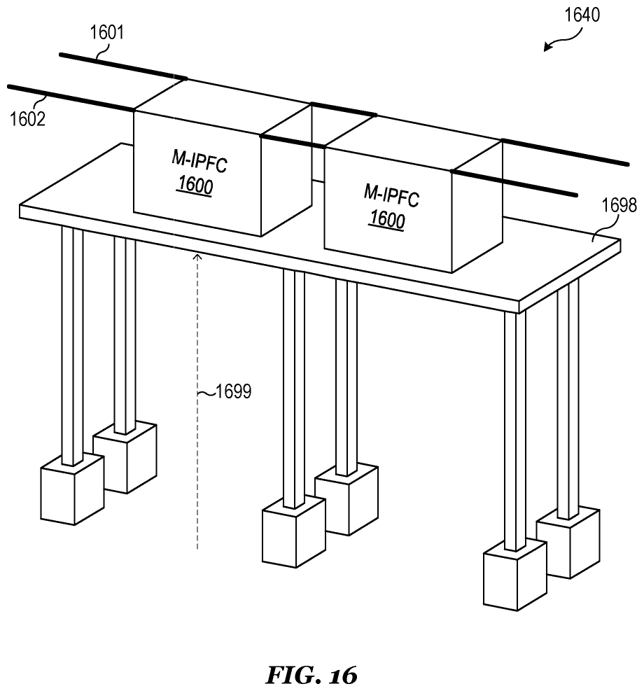

Embodiments provided below describe various power flow controllers. power flow control systems, and methods of power flow control and in particular, power flow controllers that include a shared converter that supplies a positive voltage to one power transmission line and that also supplies a negative voltage to another power transmission line. The following description describes the embodiments. FIG. 1 is used to describe an example power flow controller and FIG. 2 is used to describe a conceptually equivalent circuit. Another example power flow controller is described using FIG. 3. Two example power flow control systems are described using FIGS. 4 and 5. An example power flow control system utilizing power flow controllers in a modular configuration is described using FIG. 16. An example method of power flow control is described using FIG. 6. An example power flow control system, power flow controller, and converter that include various example bypass circuits are described using FIGS. 7-9. FIG. 10 is used to describe an example timing diagram of a response to a detected fault condition. Another example power flow control system is described using FIG. 11 while FIGS. 12 and 13 are used to describe two more example power flow controllers. FIG. 14 is used to describe another power flow control system that generalizes the two transmission line cases to complementary compensation of three or more transmission lines. An example power flow controller that includes more than one converter is described using FIG. 15.

FIG. 1 illustrates a schematic diagram of an example power flow controller that includes a converter coupled to two power transmission lines in accordance with embodiments of the invention.

Referring to FIG. 1, a power flow controller 100 includes a voltage source converter 104 configured to generate an AC voltage V_{C} across an AC voltage output 106. The voltage source converter 104 may be any suitable shared element configured to generate a controllable voltage. For example, the voltage source converter 104 is a full-bridge (H-bridge) converter in one embodiment. In another embodiment, the voltage source converter 104 is a half bridge converter. The voltage source converter 104 may also be implemented using a string of devices such as a cascade of full-bridge or half-bridge converters. In some cases, the voltage source converter 104 includes energy storage such as one or more of a battery, a super capacitor, and the like.

The power flow controller 100 is configured to be coupled to a first power transmission line 101 (Line 1) at a first pair of current input/output nodes 111 and to a second power transmission line 102 (Line 2) at a second pair of current input/output nodes 112. An element may be used to interface the voltage source converter 104 with the transmission lines. For example, this element can be a transformer with two-windings. One winding of the transformer may be connected to the voltage source converter 104 while other winding may be connected in series with the transmission line. Of course, other coupling elements may be used, including more complicated transformer solution as may be desired for a given implementation.

The AC voltage V_{C} is injected into the first power transmission line 101 with additive polarity and is injected into the second power transmission line 102 with subtractive polarity. This can be seen from the arrows indicating the direction of current flow within the power flow controller 100. As shown, a converter current I_{C} flows out of the AC voltage output 106 and generates a current I_{S1} in one direction and a complementary current I_{S2} in the opposite direction (I_{C}=I_{S1}−I_{S2}). In an implementation using series transformers, the arrangement of the transformer windings may be used to achieve the desired opposing polarity.

The combination of additive and subtractive polarity results in simultaneous injection of voltage −V_{INJ} into the first power transmission line 101 and voltage V_{INJ} of identical magnitude, but opposite sign into the second transmission line 102. Currents flow in opposite directions and complementary compensation is simultaneously performed on the first power transmission line 101 and the second power transmission line 102. That is, complementary compensation pushes power through the lightly loaded line while pulling power away from the heavily loaded line.

A controller 110 may also be included in the power flow controller 100 coupled to the voltage source converter 104 and configured to control the phase angle of the AC voltage relative to at least one of the phase angles of the first power transmission line 101 and the second power transmission line 102. Alternatively, control of the voltage source converter 104 can also be external to the power flow controller 100. Additionally, even when the controller 110 is included within the power flow controller 100, some control of the power flow controller 100 may be implemented externally.

Phase angle control may be used, for example, so that the injected voltage (±V_{INJ}) is out of phase with the line current through at least one of the first transmission line 101 and the second transmission line 102. That is, the controller 110 may control the phase angle relative to at least one of the phase angles of the first and second power transmission line currents. In one embodiment, the AC voltage injected will be in quadrature with both lines. For example, the injected AV voltage may lead the current in the first transmission line 101 by 90 degrees and lag the current in the second transmission line 102 by 90 degrees. As discussed below, the leading case may emulate a series inductor while the lagging case may emulate a series capacitor.

The controller 110, may be any suitable component configured to control the voltage generated by the voltage source converter 104. For example, the controller 110 could be implemented using sensors and microprocessor. The controller 110 could, for example, be configured to sense power transmission line current, determine the phase angle of the line current, and generate control signals for the voltage source converter 104 so that the generated voltage is at a specific phase angle with the power transmission line current (e.g., of one or both of the first and second power transmission lines).

Optionally, one or more current sensors 114 may also be included that are coupled to the first power transmission line 101 and the second power transmission line 102, respectively. The controller 110 may be coupled to the current sensors 114 and further configured to determine the phase angle of the line current of at least one of the first power transmission line 101 and the second power transmission line 102. Of course, more current sensors may also be included and the one or more current sensors 114 may be coupled to additional external components.

In various embodiments, the power flow controller 100 represents a new class of modular power electronic converter-based node compensation devices that advantageously regulate power flow by providing complementary compensation to a pair of power transmission lines (e.g., originating or terminating at a node, such as a substation. For example, the power flow controller 100 may be installed at a junction bus (see FIG. 4, for example). Because the voltage source converter 104 is injecting voltage in opposite directions into both first transmission line 101 and second transmission line 102, the required voltage is advantageously about 50% (or less) of conventional methods.

The power flow controller 100 may provide a variety of advantages over conventional power flow solutions. One such advantage may be savings in VA ratings, as both voltage and current ratings of the converters are reduced as compared to conventional solutions incorporating converters (such as SSSC configurations). This may have the benefit of reducing cost. The VA rating of the power flow controller 100 may advantageously be about 50% of a conventional SSSC solution (e.g., about 40% of the converter VA rating, but 120% of the transformer rating).

For example, the voltage rating of the power flow controller 100 may be 50% or less of the voltage rating of conventional solutions. This may be enabled by advantageously injecting a positive voltage in one power transmission line while simultaneously injecting a negative voltage in another power transmission line (compared to the voltage injection into a single line of the conventional SSSC solution).

Moreover, the current rating of the power flow controller 100 may also be 50% or less of the current rating of conventional solutions. Similar to the voltage, the current rating may be beneficially low because the converter current I_{C} is the difference between the currents in the two lines (the difference in currents in the series transformers).

The power flow controller 100 may have the advantage of being suitable for modular deployment. Modular architectures may be beneficial for allowing utilities to invest “as-they-go”. Congestion and overloading problems are solved looking at future scenarios (e.g., load growth, new renewable generation installations, etc.). Inherently, such predictions involve risks and uncertainties that cannot be avoided. This may make utilities reluctant to invest in technologies (such as PSTs) that are large capital expenditures, and have years of delay between decision making and the start of operation. Modular solutions utilizing the power flow controller 100 may beneficially allow utilities to make smaller, incremental investments.

Another potential advantage of modularity is the ability to use lower cost components and sub-systems that are high-volume. For example, a high voltage (e.g. >100 kV) transformer is typically a custom design. In contrast, a medium voltage (e.g. 3.3 kV) transformer may be suitable for mass production. Beneficially, the modular design of the power flow controller 100 may allow implementation using lower-voltage transformers in situations where high-voltage transformers would conventionally be employed.

Such modular interline power flow controllers (M-IPFCs) may advantageously be (much) lower cost due to simplification of design and complexity. Additionally, each M-IPFC may be much lower weight, affording the benefit of being installable on insulated platforms. This may then allow each equipment to have a basic insulation (BIL) rating that is (much) lower than what it otherwise would have been, if installed at the ground level. As a result, another potential advantage is that design may be further simplified by reducing insulation costs.

Another possible advantage of the power flow controller 100 is fast control, which may be enabled by using a power electronic converter as opposed to slower solutions such as variable inductors, variable capacitors, or PSTs.

The power flow controller 100 may also be advantageously smaller than conventional solutions, (e.g., PSTs). For example, the power flow controller 100 (or several) may be capable of being mounted on platforms as opposed to on the substation floor. This could, for example have the additional benefits of eliminating the need of high-voltage bushings, enable more compact transformer design due to reduced insulation requirements, and eliminate potential transformer winding-to-ground faults.

FIG. 2 illustrates a conceptually equivalent circuit of the example power flow controller of FIG. 1. Referring to FIG. 2, a conceptually equivalent circuit 200 of the power flow controller 100 is illustrated. As before, a first power transmission line 101 and a second power transmission line 102 are coupled to the power flow controller 100.

For the first power transmission line 101, the injected voltage from the voltage source converter 104 increases the impedance of the first transmission line 101 functioning like a variable inductor 216 in series with the first transmission line 101. Similarly, for second transmission line 102, the injected voltage from the voltage source converter 104 decreases the impedance of the second transmission line 102 and functioning like a variable capacitor 218 in series with the second transmission line 102.

As an example, the variable inductor 216 has a reactance X_{L1} that adds an impedance (j0.025) to the first transmission line 101 and is adjustable based on the value of the inductance. In the same way, the variable capacitance 218 has a reactance X_{L2} that subtracts an impedance (−j0.025) from the second transmission line 102 and is adjustable based on the value of the capacitance. In this way, the power flow controller 100 performs inductive compensation on the first transmission line 101 and capacitive compensation on the second transmission line 102 (complementary compensation). Since the inductance and capacitance values are both controlled by the AC voltage output by the voltage source converter 104, they change the impedance of the lines in opposite directions. In some cases, such as this example, the impedance is changed by the same amount, although the magnitude of the impedance change could also be different.

FIG. 3 illustrates a schematic diagram of an example power flow controller that includes a converter coupled to two transformers, each in series with a power transmission line in accordance with embodiments of the invention. The power flow controller of FIG. 3 is a specific implementation of the general power flow controller of FIG. 1. Similarly labeled elements may be as previously described.

Referring to FIG. 3, a power flow controller 300 includes a voltage source converter 304 configured to generate an AC voltage V_{C} across an AC voltage output 306. It should be noted that here and in the following a convention has been adopted for brevity and clarity wherein elements adhering to the pattern [x04] where ‘x’ is the figure number may be related implementations of a voltage source converter in various embodiments. For example, the voltage source converter 104 may be similar to the voltage converter 304 except as otherwise stated. An analogous convention has also been adopted for other elements as made clear by the use of similar terms in conjunction with the aforementioned numbering system.

The power flow controller 300 further includes a first transformer 321 and a second transformer 322. The first transformer 321 has a primary winding 323 coupled to the AC voltage V_{C} and has a secondary winding 324 configured to be coupled in series with a first power transmission line 301 (Line 1) at a first pair of current input/output nodes 311. Similarly, the second transformer 322 has a primary winding 325 coupled to the AC voltage V_{C} and has a secondary winding 326 configured to be coupled in series with a second power transmission line 302 (Line 2) at a second pair of current input/output nodes 312.

As indicated using transformer dot notation, the first transformer 321 has additive winding polarity 328 while the second transformer 322 has subtractive winding polarity 329. In this example, the opposite windings of the transformers serve to inject the injection voltage V_{INJ} into the first power transmission line 301 as −V_{INJ}=−0.025j resulting in an impedance increase of j0.025 while V_{NJ} is injected into the second power transmission line 302 as V_{INJ}=0.025j decreasing the impedance by j0.025.

In various embodiments, the first transformer 321 and the second transformer 322 are lower-voltage transformers. Meanwhile, the first power transmission line 301 and the second power transmission line 302 may still be high-voltage (e.g. phase-to-phase voltage greater than about 15 kV, and higher). For example, each of the first transformer 321 and the second transformer 322 may operate at voltages up to a maximum of 1-5% of the phase-to-phase voltage. Additionally, due to modular structure, each of the transformers inside the modules 500, may have a terminal voltage rating that is much lower. For instance, in a case when the line-to-line voltage is 230 kV, the total V_{INJ} may be 10 kV. However, an illustrative example may use 5-10 modules, and therefore, each transformer within the module may be rated to only 1-2 kV. In some embodiments, each of the first transformer 321 and the second transformer 322 have a maximum operating voltage less than about 33 kV, such as less than about 10 kV. In other embodiments, each of the first transformer 321 and the second transformer 322 are medium voltage transformers having a maximum operating voltage less than about. In one embodiment, each of the first transformer 321 and the second transformer 322 have a maximum operating voltage of about 3.3 kV, for example, 4.16 kV.

The power flow controllers described herein may be used within an AC power transmission system as part of a power flow control system. FIG. 4 illustrates a schematic diagram of an example power flow control system that includes a power flow controller coupled to two power transmission lines on parallel paths from a first area to a second area in accordance with embodiments of the invention.

Referring to FIG. 4, a power flow control system 440 includes a power flow controller 400 (labeled as an IPFC, or interline power flow controller) coupled in series with a first power transmission line 401 and a second power transmission line 402. For example, the power flow controller 400 may be any power flow controller as shown and described herein. The line current of the first power transmission line 401 enters and exits the power flow controller 400 through a first pair of current input/output nodes 411 while the line current of the second power transmission line 402 enters and exits through a second pair of current input/output nodes 412.

The first power transmission line 401 is on a first power transmission path (Path 1) from a first area (Area 1) that includes an AC power source 41 and a load 43 to a second area (Area 2) that includes an AC power source 42 and a load 44. Likewise, the second power transmission line 402 is on a second power transmission path (Path 2) from Area 1 to Area 2. Various lines and components are connected to one another using various junction buses 46, which may be considered a direct connection between system components for simplicity.

The power generation and the load for both Area 1 and Area 2 are assumed to be capable of changing dynamically based on the needs of the AC power transmission system and external factors which may or may not be controllable. The power flow control system 440 is a simple system intended to demonstrate the incorporation of the power flow controller 400 into an AC power transmission system. One or ordinary skill in the art will recognize that these concepts are extendable to systems including additional lines, power sources, loads, junction buses, power flow controllers, and other components in a wide variety of configurations.

The impedance of Path 1 and Path 2 may be different. For example, Path 2 may include an additional power transmission line 409, as shown here, but more complicated situations are of course possible in practice. In this specific example (and excluding for the moment the complementary compensation afforded by the power flow controller 400), Path 1 has a total impedance of j0.05 from the first power transmission line 401 while Path 2 has a total impedance of j0.1 equaling the sum of the j0.07 impedance of the second power transmission line 402 and the j0.03 impedance of the additional power transmission line 409.

As discussed above, when the impedance is different between parallel power transmission paths, the total power flow will be limited if the demand becomes too high because the lower impedance path will experience congestion (e.g., one or more component along the path meets or exceed its VA rating). For this reason, power flow control is implemented in the power flow control system 440 using the power flow controller 400. In this specific example, the power flow controller 400 may perform complementary compensation of the two lines by simultaneously adding an impedance j0.025 to the first power transmission line 401 of Path 1 and subtracting an impedance j0.025 (shown as adding −j0.025) to the second power transmission line 402 of Path 2.

Without compensation, the power flow through Path 1 would be limited to 1 pu, for example. Based on the relative impedances of Path 1 and Path 2, the power flow through Path 2 would then be 0.0 pu resulting in a total power P_{SEND} of only 1.5 pu. However, with the complementary compensation of the power flow controller 400, the impedance of both Path 1 and Path 2 is equal at j0.075 and allowing both paths to achieve a power flow of 1 pu. The result is an increased total power P_{SEND} of 2 pu, as shown.

The power flow controller 400 is implemented at the sending end bus, and as such offers complementary compensation at the sending end bus. However, power flow controllers may be included at various locations throughout the power flow control system 440. Mesh transmission networks can be adaptable, and the direction of power flow may even reverse under certain conditions. Therefore, although only one power flow controller 400 is shown for the sake of simplicity, it should be recognized that many power flow controllers can be included in a given power flow control system.

The power flow controllers (i.e. IPFCs) described herein may advantageously be utilized in a modular fashion. That is, multiple IPFC circuits may be connected in various configurations to achieve desired compensation capabilities for a given system. FIG. 5 illustrates a schematic diagram of a power flow control system that includes multiple power flow controllers coupled in series to two power transmission lines in accordance with embodiments of the invention. The power flow control system of FIG. 5 is a specific implementation of the general power flow control system of FIG. 4. Similarly labeled elements may be as previously described.

Referring to FIG. 5, a power flow control system 540 includes multiple power flow controllers 500 (labeled as M-IPFCs) coupled in series with each other and with a first power transmission line 501 and a second power transmission line 502. For example, the power flow controllers 500 may be any power flow controller as shown and described herein. Again, the first power transmission line 501 and the second power transmission line 502 are respective portions of two paths (Path 1 and Path 2) between Area 1 and Area 2.

Although it will be apparent that line current enters and exits each of the power flow controllers 500, the line currents of the first power transmission line 501 and the second power transmission line 502 are shown as entering and exiting a first pair of current input/output nodes 511 and a second pair of current input/output nodes 512 respectively that bracket the power flow controllers 500 to illustrate the combined functionality of the power flow controllers 500 as larger power flow controller. That is, the modular nature of the power flow controllers 500 may be advantageously utilized by combining multiple power flow controllers 500 to meet the needs of various points in the AC power transmission system.

In this specific example, a number n (at least two) power flow controllers 500 have been combined to achieve the same complementary compensation demonstrated by the single power flow controller 400 in power flow control system 440. The individual M-IPFCs in the power flow controllers 500 may advantageously have a lower VA rating, a smaller physical size, and be subject to more flexibility, such as being mounted on platforms and therefore requiring isolation to a floating voltage as opposed to being mounted on a substation floor (compared to PSTs, for example, which require much larger cumbersome ground isolation).

A high-level illustration of an example power flow control system including multiple power flow controllers in a modular arrangement installed on an above-ground platform is shown in FIG. 16 in accordance with embodiments of the invention. Referring to FIG. 16, a power flow control system 1640 include multiple power flow controllers 1600 (labeled as M-IPFC) installed (e.g. mounted) on a platform 1698 a distance 1699 above the ground. The modular nature of the power flow controllers 1600 may allow smaller equipment to be used in the M-IPFC implementation enabling installation on a platform. Notably, the power flow controllers 1600 may be insulated only from the platform (e.g. floating) while the platform 1698 is insulated from true ground. This may advantageously result in a lower BIL rating for the power flow controllers 1600 than if installed at the ground level.

FIG. 6 illustrates a high-level flowchart of a method of power flow control in an AC power transmission system using one or more power flow controllers coupled to two power transmission lines in accordance with embodiments of the invention. The method of FIG. 6 may be combined with other method steps described herein and be performed using the systems and apparatuses as described herein. Although shown in a logical order, the arrangement and numbering of the steps of FIG. 6 are not intended to be limited. The method steps of FIG. 6 may be performed in any suitable order or concurrently with one another as may be apparent to a person of skill in the art.

Referring to FIG. 6, a method 650 of power flow control includes step 651 of reading system data indicating a present state of an AC power system. Step 652 includes determining that there is power flow congestion on a first power transmission line of the AC power system using load flow calculations of the AC power system determined using the system data. In response to determining that there is power flow congestion, the method 650 includes a step 653 of performing complementary compensation of the first power transmission line and a second power transmission line of the AC power system by injecting an out of phase voltage into the first power transmission line with additive polarity and injecting the out of phase voltage into the second power transmission line with subtractive polarity using a power flow controller coupled to both the first and second power transmission lines.

The process (e.g., step 651, step 652, and step 653) may then be repeated, illustrated as step 654 in the method 650. For example, the method 650 may be reinitiated on demand, automatically based on monitored system conditions, after a predetermined period of time, etc.

Additionally, as shown, the step 653 of performing the complementary compensation may include various sub-steps such as step 655 of determining new set points for the power flow controller according to the load flow, step 656 of determining required voltage of the power controller according to the load flow, and step 657 of regulating output voltage of the power flow controller using the new set points and the required voltage.

Faults (e.g., both internal and external) may cause damage to power flow controllers included in a power flow control system. One method of handling faults is to bypass the sensitive components, such as power flow controllers. FIG. 7 illustrates a schematic diagram of an example power flow control system including a power flow controller and two bypass circuits coupled to two power transmission lines in accordance with embodiments of the invention. The power flow system depicted in FIG. 7 is a specific implementation of the general power flow control system of FIG. 4. Similarly labeled elements may be as previously described.

Referring to FIG. 7, a power flow control system 740 includes a power flow controller 700 (labeled as an IPFC) coupled in series with a first power transmission line 701 and a second power transmission line 702. For example, the power flow controller 700 may be any power flow controller as shown and described herein including implementations using multiple IPFCs to implement the power flow controller 700, as discussed in reference to FIG. 5, for example. The line current of the first power transmission line 701 enters and exits the power flow controller 700 through a first pair of current input/output nodes 711 while the line current of the second power transmission line 702 enters and exits through a second pair of current input/output nodes 712.

An IPFC bypass circuit 761 is coupled to each of the first pair of current input/output nodes 711 in parallel with the power flow controller 700. The IPFC bypass circuit 761 is configured to isolate the power flow controller 700 from the first power transmission line 701 in the case of external and internal faults. For example, the IPFC bypass circuit 761 may be configured to detect a fault condition 765 on the first power transmission line 701 and bypass the power flow controller 700 in response (i.e. the line current flows through the IPFC bypass circuit 761 rather than through power flow controller 700).

Another IPFC bypass circuit 762 may be coupled in a similar fashion to the second pair of current input/output nodes 712 in parallel with the power flow controller 700. The operation of the IPFC bypass circuit 762 may be similar to that of the IPFC bypass circuit 761, except that the IPFC bypass circuit 762 is configured to detect faults on the second power transmission line 702. In some embodiments, fault detection may be performed externally. The fault detection and control for both bypass circuits may also be performed by a common controller, whether included internally in the power flow controller 700 or externally in the power flow control system 740.

A possible scenario of when one of the lines (first power transmission line 701) has a fault condition 765 is shown here. This may result in large current (e.g. 5-10× more than normal current levels. Such currents can destroy a power electronic converter within the IPFC. Hence, at least one IPFC bypass circuit is added (e.g. one IPFC bypass circuit 761, 762 per line). When an external line fault (e.g. fault condition 765) is detected the IPFC bypass circuit is switched ON, and all the currents are diverted it. Under normal operation the IPFC bypass circuit is OFF, and all the line current flows through the IPFC (i.e. power flow controller 700).

Another possible advantage of the power flow controller 700 with included IPFC bypass circuits is to ensure decoupling between the compensated line and the line with a fault when a fault occurs on one of the lines.

Yet another possible advantage of the power flow controller 700 is to reduce the bypass requirements compared to conventional flow control solutions. For example, bypass solutions for series capacitors may be expensive in comparison to optimal bypass solutions for power flow controller 700. For example, thyristor-based switches or CapThor™ switches may be less expensive and may be optimal whereas conventional solutions would require significantly more expensive switches.

FIG. 8 illustrates a schematic diagram of an example bypass circuit including a fault detection device, a fast bypass switch, and a slow bypass switch in accordance with embodiments of the invention. The bypass circuit of FIG. 8 is a specific implementation of the general bypass circuit described in reference to FIG. 7. Similarly labeled elements may be as previously described.

Referring to FIG. 8, a bypass circuit 861 includes a fault detection device 864, a fast bypass switch 866, and a slow bypass switch 868 connected in parallel with one another. Each of the components of the bypass circuit 861 is configured to serve a specific purpose during a specific time period of a fault event. For example, the fault detection device 864 may rapidly shunt current away from one or more power flow controllers as the fault occurs and indicate that a fault condition is occurring.

Some time later the fast bypass switch 866 may close in response to a trigger signal generated by the fault detection device 864 or by another component monitoring the fault detection device 864. More current is able to be conducted through the fast bypass switch and better isolation of a power flow controller from the power transmission line is achieved.

After more time passes, the slow bypass switch 868 may close in response to the trigger signal. The slow bypass switch 868 may be configured to conduct even more current than the fast bypass switch 866 and afford even better isolation of a power flow controller from the power transmission line. For example, the closing of the slow bypass switch 868 may represent a final state of the bypass circuit 861 that fully isolates the power flow controller from the power transmission line during the fault (and optionally for a desired time after or until manual reset).

As shown, the fault detection device 864 may include a metal-oxide varistor (MOV), but may also be implemented in other manners. An additional mechanism for monitoring the fault detection device 864 and generating a fault detection trigger signal may also be included, or may be implemented externally.

The fast bypass switch 866 may be a switch of intermediate VA rating that is configured to close in response to the trigger signal. In one embodiment, the fast bypass switch 866 is a thyristor-based switch. In another embodiment, the fast bypass switch 866 is a plasma switch, such as a CapThor™ available from Hitachi Energy. In yet another embodiment, the fast bypass switch 866 is a spark gap switch.

The slow bypass switch 868 may be configured to close in a permanent or semi-permanent fashion some time after the fast bypass switch closes 866. For example, the slow bypass switch 868 may be a mechanical switch. In one embodiment, the slow bypass switch 868 is a Thomson coil actuator.

Of course, the specific implementation of the fault detection device 864, the fast bypass switch 866, and the slow bypass switch will depend on the specific details of a given AC power transmission system as will be apparent to those of ordinary skill in the art. Additional switches may be included in some implementations, while fewer switches may be included in others.

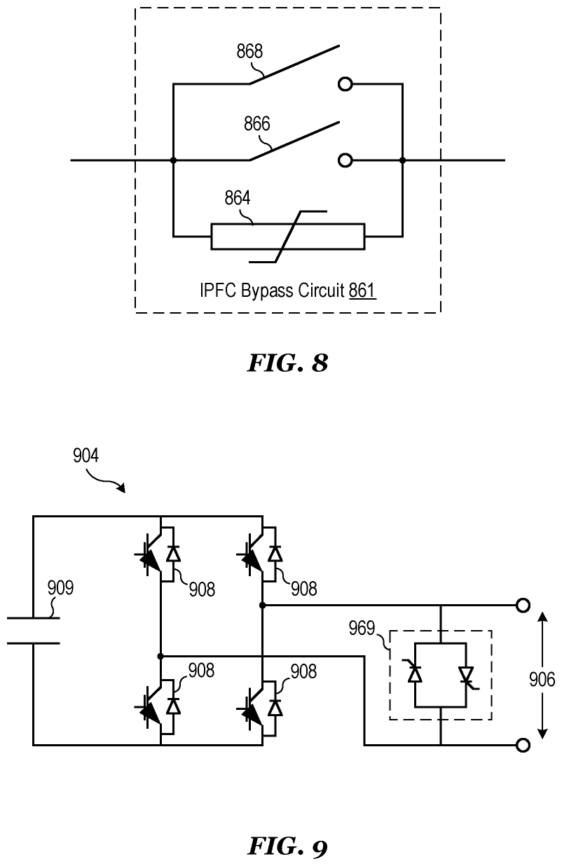

FIG. 9 illustrates a schematic diagram of an example converter implemented in a full-bridge configuration in accordance with embodiments of the invention. The converter if FIG. 9 is a specific implementation of other general converters described herein, such as the converter of FIG. 1, for example. Similarly labeled elements may be as previously described.

Referring to FIG. 9, a voltage source converter 904 includes four switches 908 in a full-bridge (H-bridge) configuration. Of course, other configurations such as a half-bridge configuration are also possible. The voltage source converter 904 converts a voltage 909 into an AC voltage V_{C} at an AC voltage output 906. Optionally, a converter bypass circuit 969 may be included coupled to the AC voltage output 906 that is configured to bypass the voltage source converter 904 in response to a fault condition (e.g., in response to a fault detection trigger signal). In one embodiment, the converter bypass circuit 969 is a thyristor-based switch (as shown), but other implementations are of course possible.

FIG. 10 illustrates an example timing diagram of a response to a detected fault condition by bypass circuits of a power control system in accordance with embodiments of the invention. The timing diagram of FIG. 10 may be an example timing response of the bypass circuits of FIGS. 7-9, for example. Similarly labeled elements may be as previously described.

Referring to FIG. 10, a timing diagram 1050 includes a fault condition 1065 (here represented as a discrete condition, but which may in practice correspond with one or more system values meeting or exceeding a predetermined threshold). A fault detection device detects the fault condition 1065 after a first time T₁, and generates a fault detection trigger signal 1066 that is sent to one or more bypass components (e.g., bypass circuits including bypass switches).

For example, as discussed above in reference to FIG. 9, when a converter bypass circuit is included, the converter bypass circuit may receive the fault detection trigger signal 1066 after a time T₂ (that may be fast relative to other bypass switches, e.g., <1 ms such as about 0.5 ms) causing a bypass switch of the converter bypass circuit to close in response to. The state of the converter bypass circuit is shown as the S_{CELL-BYPASS} 1067.

Additionally or alternatively, as discussed above in reference to FIG. 8, a fast bypass switch may receive the fault detection trigger signal 1066 after a longer time T₃ (e.g., about 0.5 ms to about 2 ms, although of course T₂ and T₃ could be equal, such as if both are thyristor-based, or even reversed in some implementations). The fast bypass switch may then close in response to receiving the fault detection trigger signal 1066, the state of which is shown as the S_{FAST} 1068. Similarly, a slow bypass switch may receive the fault detection trigger signal 1066 after a still longer time T₄ (e.g., <10 ms or at times <6 ms, but slower than the fast bypass switch). The slow bypass switch may then close in response to receiving the fault detection trigger signal 1066, which is shown as the state S_{SLOW} 1069.

As already mentioned, there is not requirement to include all of the above switches. In some specific implementations, the fast switch may be omitted or there may be no need for a slow switch. There may also be a need for more switches or switches with different relative response times. Furthermore, additional fault mitigation may take place in addition to that described thus far, such as turning off the switching devices of the converter at an even faster timescale than a converter bypass circuit to provide even more protection of the converter switches.

FIG. 11 illustrates a schematic diagram of an example power flow control system including multiple power flow controllers and two bypass circuits coupled to two power transmission lines in accordance with embodiments of the invention. The power flow system depicted in FIG. 11 is a specific implementation of the more general power flow control systems of FIGS. 5 and 7. Similarly labeled elements may be as previously described.

Referring to FIG. 11, a power flow control system 1140 includes multiple power flow controllers 1100 (labeled as M-IPFCs) coupled in series with each other and with a first power transmission line 1101 and a second power transmission line 1102. The line current of the first power transmission line 1101 enters and exits the power flow controllers 1100 through a first pair of current input/output nodes 1111 while the line current of the second power transmission line 1102 enters and exits through a second pair of current input/output nodes 1112.

An IPFC bypass circuit 1161 is coupled to each of the first pair of current input/output nodes 1111 in parallel with the power flow controllers 1100. That is, the single IPFC bypass circuit 1161 may be used to bypass all of the power flow controllers 1100. Of course, more than one IPFC bypass circuit could also be used, including one per power flow controller depending on the specific details of a given implementation. Similarly, another IPFC bypass circuit 1162 may be coupled in a similar fashion to the second pair of current input/output nodes 1112 in parallel with the power flow controllers 1100. The same reasoning applies the IPFC bypass circuit 1162 as for the IPFC bypass circuit 1161. Additionally, although symmetry may occur, there is no requirement that each transmission line include the same number of IPFC bypass circuits.

FIG. 12 illustrates a schematic diagram of an example power flow controller that includes a converter coupled to two adjustable transformers, each in series with a power transmission line in accordance with embodiments of the invention. The power flow controller of FIG. 12 is a specific implementation of the more general power flow controller of FIG. 3. Similarly labeled elements may be as previously described.

Referring to FIG. 12, a power flow controller 1200 includes a voltage source converter 1204 configured to generate an AC voltage V_{C} across an AC voltage output 1206. The power flow controller 1200 is similar to the power flow controller 300, except that one or both of the transformers are implemented as adjustable transformers (e.g., tap changers) that have and adjustable winding turns ratio. For example, an adjustable transformer 1271 is coupled to the voltage source converter 1204 and a first power transmission line 1201 while an adjustable transformer 1272 is coupled to the voltage source converter 1204 and a second power transmission line 1202. Therefore, in addition to controlling the injected voltage of the power flow controller 1200, the voltage scaling may be advantageously controlled using adjustable transformers (e.g., with an internal controller or externally).

FIG. 13 illustrates a schematic diagram of an example power flow controller that includes at least one disconnect switch configured to disconnect a converter from one of two power transmission lines in accordance with embodiments of the invention. The power flow controller of FIG. 13 is a specific implementation of the general power flow controller of FIG. 1. Similarly labeled elements may be as previously described.

Referring to FIG. 13, a power flow controller 1300 includes a voltage source converter 1304 configured to generate an AC voltage V_{C} across an AC voltage output 1306. The power flow controller 1300 is configured to be coupled to a first power transmission line 1301 (Line 1) at a first pair of current input/output nodes 1311 and to a second power transmission line 1302 (Line 2)at a second pair of current input/output nodes 1312. Additionally, the power flow controller 1300 further includes one or more disconnect switches 1374 (e.g., electronic switches, mechanical switches, a combination thereof, etc.) that are configured to disconnect the voltage source converter 1304 from the one of the first power transmission line 1301 or the second power transmission line 1302.

In the event that one of the disconnect mechanisms 1374 is activated (e.g., opened in this case), then single compensation can be performed on the remaining coupled transmission line (e.g., using a transformer as described elsewhere herein). This may advantageously allow more flexible usage of the power flow controller 1300, when, for example, one of the transmission lines does not need to be adjusted, or when there is a fault on one of the transmission lines. Indeed, one alternative way to implement a disconnect mechanism is using a bypass circuit, using one or more switches to allow the line current to bypass the power flow controller 1300 so that the other line alone receives the injected voltage and single compensation is performed.

FIG. 14 illustrates a schematic diagram of an example an example power flow control system that includes a power flow controller coupled to three or more power transmission lines on parallel paths from a first area to a second area in accordance with embodiments of the invention. The power flow control system of FIG. 14 is a general implementation of the more specific power flow control system of FIG. 4. Similarly labeled elements may be as previously described.

Referring to FIG. 14, a power flow control system 1440 includes a power flow controller 1400 coupled in series with a first power transmission line 1401 and a second power transmission line 1402. For example, the power flow controller 1400 may be any power flow controller as shown and described herein. A voltage source converter 1404 is included in the power flow controller 1400. The line current of the first power transmission line 1401 enters and exits the power flow controller 1400 through a first pair of current input/output nodes 1411 while the line current of the second power transmission line 402 enters and exits through a second pair of current input/output nodes 1412.

However, in addition to the first and second transmission lines, at least one additional power transmission line 1403 is also coupled in series with the power flow controller 1400. The polarity of the coupling may be additive or subtractive depending on, for example, the impedance of each of the corresponding paths. Accordingly, complementary compensation is performed on more than two transmission lines using a single power flow controller 1400 (or a string of multiple power flow controllers as the case may be).

As shown, one or more disconnect switches 1474 may also optionally be included to allow for complementary compensation of subsets of transmission lines as desired by disconnecting one or more of the transmission lines at a time (e.g., disconnecting transformers by opening a switch or bypassing a transformer by closing a switch) and performing compensation on the remaining coupled transmission lines (e.g., using the remaining transformers).

FIG. 15 illustrates a schematic diagram of an example power flow controller that includes multiple converters coupled to two transformers, each in series with a power transmission line in accordance with embodiments of the invention. The power flow controller of FIG. 15 is a general implementation of the more specific power flow controller of FIG. 3. Similarly labeled elements may be as previously described.

Referring to FIG. 15, a power flow controller 1500 includes multiple voltage source converters 1504 configured to generate an AC voltage V_{C} across an AC voltage output 1506. The power flow controller 1500 further includes a first transformer 1521 and a second transformer 1522. The first transformer 1521 is configured to be coupled in series with a first power transmission line 1501 (Line 1) at a first pair of current input/output nodes 1511. Similarly, the second transformer 322 is configured to be coupled in series with a second power transmission line 1502 (Line 2) at a second pair of current input/output nodes 1512.

While the power flow controller 300 uses a single voltage source converter 304 coupled to a transformer for each transmission line, the power flow controller 1500 uses more than one (n voltage source converters 1504 each generating an AC voltage V_{C} totaling nV_{C} split between the coupled transformers (here shown as two, but of course more is possible, as shown in FIG. 14, for example). Additionally, there is no requirement that any of the specifications of the independent voltage source converters 1504 are the same, although here they are shown to be a string of similar converters. For example, the voltage output for any one of the voltage source converters 1504 could be different (e.g., to facilitate finer control over voltage, etc.).

Example embodiments of the invention are summarized here. Other embodiments can also be understood from the entirety of the specification as well as the claims filed herein.

Example 1. A power flow controller including: a voltage source converter including an AC voltage output configured to be simultaneously coupled to a first power transmission line and a second power transmission line, the voltage source converter being configured to generate, at the AC voltage output, AC voltage to be injected into the first power transmission line with additive polarity and into the second power transmission line with subtractive polarity to perform complementary compensation on the first and second power transmission lines; and a controller coupled to the voltage source converter and configured to control the phase angle of the AC voltage relative to at least one of the phase angles of the first and second power transmission line currents.

Example 2. The power flow controller of example 1, further including: a first transformer including a first primary winding coupled to the AC voltage, and a first secondary winding configured to be coupled in series with the first power transmission line such that an injection voltage is injected into the first power transmission line with the additive polarity; and a second transformer including a second primary winding coupled to the AC voltage, and a second secondary winding configured to be coupled in series with the second power transmission line such that the injection voltage is injected into the second power transmission line with the subtractive polarity.

Example 3. The power flow controller of example 2, where the power flow controller is a modular power flow controller, each of the first transformer and the second transformer being configured to operate at a maximum voltage less than about 10 kV while the first and second power transmission line currents having a voltage greater than about 33 kV.

Example 4. The power flow controller of one of examples 2 and 3, where the first transformer has additive winding polarity and the second transformer has subtractive winding polarity.

Example 5. The power flow controller of one of examples 2 to 4, further including: at least one disconnect switch configured to disconnect one of the first or second transformers from the voltage source converter to enable single compensation of the remaining transformer.

Example 6. The power flow controller of one of examples 2 to 5, further including: one or more additional transformers, each including an additional primary winding coupled across the AC voltage, and an additional secondary winding configured to be coupled in series with a corresponding additional power transmission line such that the injection voltage is injected into the corresponding additional power transmission line.

Example 7. The power flow controller of example 6, further including: at least one disconnect switch configured to disconnect one or more of the first transformer, the second transformer, and the one or more additional transformers from the voltage source converter to enable compensation using only the remaining transformers.

Example 8. The power flow controller of one of examples 1 to 7, further including: a first bypass switch coupled across the AC voltage and configured to bypass the voltage source converter by closing in response to receiving a fault detection trigger signal.

Example 9. The power flow controller of one of examples 1 to 8, further including: at least one current sensor coupled to the controller, the controller being further configured to determine the phase angle of the line current of at least one of the first and second power transmission lines.

Example 10. A power flow control system including: a first pair of current input/output nodes configured to be coupled in series with a first power transmission line; a second pair of current input/output nodes configured to be coupled in series with a second power transmission line; and a first IPFC circuit including a first voltage source converter configured to output a first AC voltage out of phase with line currents of the first and second power transmission lines, a first line one transformer including a primary winding coupled across the first AC voltage, and a secondary winding coupled between the first pair of current input/output nodes, the first line one transformer having additive winding polarity, a first line two transformer including a primary winding coupled across the first AC voltage, and a secondary winding coupled between the second pair of current input/output nodes, the first line two transformer having subtractive winding polarity.

Example 11. The power flow control system of example 10, further including: an IPFC bypass circuit coupled to each of the first pair of current input/output nodes in parallel with the first IPFC circuit, the IPFC bypass circuit including a fault detection device configured to detect a fault condition on the first power transmission line and generate a fault detection trigger signal in response, and a bypass switch configured to bypass the first IPFC circuit by closing in response to receiving the fault detection trigger signal.

Example 12. The power flow control system of one of examples 10 to 11, further including: one or more additional IPFC circuits, each including an additional voltage source converter configured to output an additional AC voltage out of phase with line currents of the first and second power transmission lines, an additional line one transformer including a primary winding coupled across the additional AC voltage, and a secondary winding coupled between the first pair of current input/output nodes in series with the secondary winding of the first line one transformer, the additional line one transformer having additive winding polarity, an additional line two transformer including a primary winding coupled across the additional AC voltage, and a secondary winding coupled between the second pair of current input/output nodes in series with the secondary winding of the first line two transformer, the additional line two transformer having subtractive winding polarity.

Example 13. The power flow control system of example 12, further including: an IPFC bypass circuit coupled to each of the first pair of current input/output nodes in parallel with the first IPFC circuit and the one or more additional IPFC circuits, the IPFC bypass circuit including a fault detection device configured to detect a fault condition on the first power transmission line and generate a fault detection trigger signal in response, and a bypass switch configured to bypass the first IPFC circuit and the one or more additional IPFC circuits by closing in response to receiving the fault detection trigger signal.

Example 14. The power flow control system of one of examples 10 to 13, where the first IPFC circuit further includes a second voltage source converter configured to output a second AC voltage out of phase with line currents of the first and second power transmission lines, where the primary winding of the first line one transformer is further coupled across the second AC voltage, and where the primary winding of the first line two transformer is further coupled across the second AC voltage.

Example 15. The power flow control system of example 14, where the first IPFC circuit further includes a first converter bypass switch coupled across the first AC voltage and configured to bypass the first voltage source converter by closing in response to receiving a fault detection trigger signal, and a second converter bypass switch coupled across the second AC voltage and configured to bypass the second voltage source converter by closing in response to receiving the fault detection trigger signal.

Example 16. The power flow control system of one of examples 10 to 15, where the IPFC circuit is a modular IPFC circuit, each of the first line one transformer and the second line one transformer being configured to operate at a maximum voltage less than about 10 kV while the first and second power transmission line currents having a voltage greater than about 33 kV.

Example 17. A method of power flow control including: reading system data indicating a present state of an AC power system; determining that there is power flow congestion on a first power transmission line of the AC power system using load flow calculations of the AC power system determined using the system data; and in response to determining that there is power flow congestion, performing complementary compensation of the first power transmission line and a second power transmission line of the AC power system by injecting an out of phase voltage into the first power transmission line with additive polarity and injecting the out of phase voltage into the second power transmission line with subtractive polarity using a power flow controller coupled to both the first and second power transmission lines.

Example 18. The method of example 17, further including: repeating the steps of reading the system data, determining that there is power flow congestion, and performing the complementary compensation after a predetermined period of time.

Example 19. The method of one of examples 17 and 18, where the performing the complementary compensation of the first and second power transmission lines includes determining new set points for the power flow controller according to the load flow calculations, determining required voltage of the power controller according to the load flow calculations, and regulating output voltage of the power flow controller using the new set points and the required voltage.

Example 20. The method of one of examples 17 to 19, where determining that there is power flow congestion on the first power transmission line includes determining that the VA rating of at least one component of a path including the first power transmission line is met or exceeded.

Example 21. The method of one of examples 17 to 20, further including: detecting a fault condition on the first power transmission line; generating a fault detection trigger signal in response to detecting the fault condition; and bypassing the power flow controller using a bypass switch by closing the bypass switch in response to receiving the fault detection trigger signal.

Example 22. The method of example 21, further including: sending the fault detection trigger signal to the power flow controller; and bypassing a converter of the power flow controller in response to the power flow controller receiving the fault detection trigger signal.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A power flow controller comprising:
a voltage source converter comprising an alternating current (AC) voltage output configured to be simultaneously coupled to a first power transmission line and a second power transmission line, the voltage source converter being configured to generate, at the AC voltage output, AC voltage to be injected into the first power transmission line with additive polarity and into the second power transmission line with subtractive polarity to perform complementary compensation on the first and second power transmission lines; and
a controller coupled to the voltage source converter and configured to control the phase angle of the AC voltage relative to at least one of the phase angles of the first and second power transmission line currents.

2. The power flow controller of claim 1, further comprising:
a first transformer comprising
a first primary winding coupled to the AC voltage, and
a first secondary winding configured to be coupled in series with the first power transmission line such that an injection voltage is injected into the first power transmission line with the additive polarity; and
a second transformer comprising
a second primary winding coupled to the AC voltage, and
a second secondary winding configured to be coupled in series with the second power transmission line such that the injection voltage is injected into the second power transmission line with the subtractive polarity.

3. The power flow controller of claim 2, wherein the power flow controller is a modular power flow controller, each of the first transformer and the second transformer being configured to operate at a maximum terminal voltage less than about 10 kV while the first and second power transmission lines having a line-to-line voltage greater than about 33 kV.

4. The power flow controller of claim 2, wherein the first transformer has additive winding polarity and the second transformer has subtractive winding polarity.

5. The power flow controller of claim 2, further comprising:
at least one disconnect switch configured to disconnect one of the first or second transformers from the voltage source converter to enable single compensation of the remaining transformer.

6. The power flow controller of claim 2, further comprising:
one or more additional transformers, each comprising
an additional primary winding coupled across the AC voltage, and
an additional secondary winding configured to be coupled in series with a corresponding additional power transmission line such that the injection voltage is injected into the corresponding additional power transmission line.

7. The power flow controller of claim 6, further comprising:
at least one disconnect switch configured to disconnect one or more of the first transformer, the second transformer, and the one or more additional transformers from the voltage source converter to enable compensation using only the remaining transformers.

8. The power flow controller of claim 1, further comprising:
a first bypass switch coupled across the AC voltage and configured to bypass the voltage source converter by closing in response to receiving a fault detection trigger signal.

9. The power flow controller of claim 1, further comprising:
at least one current sensor coupled to the controller, the controller being further configured to determine the phase angle of the line current of at least one of the first and second power transmission lines.

10. A method of power flow control comprising:
reading system data indicating a present state of an alternating current (AC) power system;
determining that there is power flow congestion on a first power transmission line of the AC power system using load flow calculations of the AC power system determined using the system data; and
in response to determining that there is power flow congestion, performing complementary compensation of the first power transmission line and a second power transmission line of the AC power system by injecting an out of phase voltage into the first power transmission line with additive polarity and injecting the out of phase voltage into the second power transmission line with subtractive polarity using a power flow controller coupled to both the first and second power transmission lines.

11. The method of claim 10, further comprising:
repeating the steps of reading the system data, determining that there is power flow congestion, and performing the complementary compensation after a predetermined period of time.

12. The method of claim 10, wherein the performing the complementary compensation of the first and second power transmission lines comprises
determining new set points for the power flow controller according to the load flow calculations,
determining required voltage of the power controller according to the load flow calculations, and
regulating output voltage of the power flow controller using the new set points and the required voltage.

13. The method of claim 10, wherein determining that there is power flow congestion on the first power transmission line comprises determining that the volt-ampere (VA) rating of at least one component of a path including the first power transmission line is met or exceeded.

14. The method of claim 10, further comprising:
detecting a fault condition on the first power transmission line;
generating a fault detection trigger signal in response to detecting the fault condition; and
bypassing the power flow controller using a bypass switch by closing the bypass switch in response to receiving the fault detection trigger signal.

15. The method of claim 14, further comprising:
sending the fault detection trigger signal to the power flow controller; and
bypassing a converter of the power flow controller in response to the power flow controller receiving the fault detection trigger signal.
